(19) United States
(12) Patent Application Publication
(10) Pub. No.: US 2012/0209535 A1
(43) Pub. Date: Aug. 16, 2012

(54) METHOD FOR GENERATING BIOMARKER REFERENCE PATTERNS

(75) Inventors: Alexandre Prokoudine, Berlin (DE); Tilmann B. Walk, Kleinmachnow (DE); Jan C. Wiemer, Berlin (DE); Ralf Looser, Berlin (DE); Michael Manfred Herold, Berlin (DE); Bennard van Ravenzwaay, Altrip (DE); Werner Mellert, Hassloch (DE); Eric Fabian, Speyer (DE); Volker Strauss, Bad Durkheim (DE); Hennicke Kamp, Bischheim (DE)

(73) Assignee: BASF Plant Science Company GmbH, Ludwigshafen (DE)

(21) Appl. No.: 13/503,268

(22) PCT Filed: Oct. 14, 2010
(86) PCT No.: PCT/EP2010/065450

§ 371 Date: Apr. 20, 2012

Related U.S. Application Data
(60) Provisional application No. 61/255,876, filed on Oct. 29, 2009.

(30) Foreign Application Priority Data
Oct. 21, 2009 (EP) 09173689.2

(51) Int. Cl. G06F 19/28

(52) U.S. Cl. 702/19

(57) ABSTRACT

The present invention relates to methods for evaluating biomarkers. In particular, the invention relates to a method for establishing at least one pattern for at least one pre-defined effector having at least one effect on a biological system, which effect is capable of being determined, to a method of establishing a class of effectors for a pre-defined effect or group of effects, to a method for identifying at least one effect of a pre-defined effector and to a computer program and a computer adapted to carry out these methods.

The present invention relates to methods for evaluating biomarkers. In particular, the invention relates to a method for establishing at least one pattern for at least one pre-defined effector having at least one effect on a biological system, which effect is capable of being determined, to a method of establishing a class of effectors for a pre-defined effect or group of effects, to a method for identifying at least one effect of a pre-defined effector and to a computer program and a computer adapted to carry out these methods.

Biological systems such as individual organisms or populations of organisms will, as a rule, respond to effectors with a change of state, in particular a change in their biochemical properties or biochemical constitution. In this context, an individual organism on which an external or internal effector acts responds, for example, by modified cell activities. This modified activity will then also result in a change in the constitution or quantitative composition of the cellular molecules. In this context, both changes in the transcriptional activities or the protein function and protein turnover as well as metabolic changes may be observed. The latter will, consequently, lead to a change in the qualitative and/or quantitative metabolite constitution of the organism as a result of the effector (modification of the metabolome). Similar changes in the biochemical constitution or properties can be observed in populations of organisms which form a biological system. Such populations of organisms which form a biological system are, for example, microorganisms which form a locally delimitable micro ecosystem.

For many biologically relevant questions it is necessary to assess the influence of effectors on biological systems. In this manner, it is possible better to avoid or to exploit interfering or advantageous influences of effectors. For example, chemicals acting as effectors may have an e.g. toxic effect on a biological system or else a beneficial or healing effect. Almost all effectors ranging from chemicals through physical influences such as radiation to intended or unintended genetic modifications will, ultimately, influence the metabolome. This influence frequently already occurs at a very early stage after the action of the effector so that modifications of the metabolome can be used as an early detection mechanism for particular effects or consequences which an effector may bring about.

Modifications of the metabolome, induced by effectors, will, as a rule, affect not only one metabolite whose status might then be used as what is known as a biomarker. Frequently, a variety of metabolites are affected. Effectors which mediate the same effect need not always modify the same metabolites in this context. However, as a rule, there is a set of key metabolites which is modified by effectors which mediate the same effect. This set of modified key metabolites can currently not always be identified in an efficient manner. Above all, the problem is that most effectors cause not only the characteristic key metabolites, but also individual metabolite modifications which are characteristic only of the individual effector, but are not caused by other effectors which cause the same effect. In addition, there are metabolic modifications which are not related to the effector applied, but are induced by other influences or by variations of the metabolites which are merely caused by the variability due to measurement techniques.

Nevertheless, it would be useful for a very wide range of applications to extract, from a metabolome, the key metabolites which are modified early as a response of a biological system to specific effectors. In this manner, chemicals which are toxic to biological systems might be identified even at an early point in time. Likewise, the therapeutic activity of candidate active substances might be determined at an early point in time and in a reliable manner, and potential side effects might be ruled out. Advantageous or harmful influences of environmental factors for biological systems in general might likewise be identified. Ultimately, diseases might also be identified earlier, and advantageous or disadvantageous effects of modifications of the genetic material might be studied better.

It is an object of the present invention to provide a method by means of which responses of biological systems to specific effectors can efficiently be studied or predicted, or by means of which a deliberate search can be made for particular effectors capable of causing a predetermined response of the biological system.

This object is achieved by methods and computer programs with the features of the independent claims; advantageous refinements of the invention, which may be implemented individually or in any desired combination, are presented in the dependent claims.

The methods comprise the method steps described below. The method steps are preferably carried out in the order presented. In principle, however, it is also possible to carry out individual or several method steps in a different order. Thus, for example, it is also possible to carry out individual or several method steps chronologically in parallel or chronologically overlapping. Furthermore, individual or several method steps or the entire methods may also be carried out repeatedly. For example, method steps a) to j1) which are described hereinbelow may be carried out repeatedly individually or as a whole, for example with a number of repetitions of at least two, a number of repetitions of at least five and especially preferably a number of repetitions of at least 10 or even at least 20. Furthermore, the methods may also comprise additional method steps which are not mentioned in the claims.

In a first aspect, the invention relates to a method for establishing at least one pattern for at least one pre-defined effector having at least one determinable effect on a biological system, comprising the following steps:
a) providing at least one profile (124) of the pre-defined effector;
b) comparing at least one value of at least one biomarker of the profile (124), preferably of a plurality of or all the biomarkers of the profile (124), with at least one significance threshold in order to ascertain whether the biomarker is significant;
c) combining significant biomarkers of the profile (124) to give a pattern.

By means of this method, it is possible to compile a pattern for a pre-defined effector, for example a novel effector which has not been studied as yet, that is, for example, a set of biomarkers which experience a significant modification when the biological system is exposed to it.

Here and hereinbelow, “providing” may, in principle, be understood as any way of creating the availability of the item to be provided. Providing may, in particular, be carried out in electronic form, for example on a volatile or nonvolatile data memory which can be accessed during the method, so that the item to be provided, in this case the at least one profile of the pre-defined effector, is available. As an alternative or additionally, providing may also involve the use of, for example, a database. However, other types of providing are also possible in principle. Thus, for example, providing may also be carried out manually by a user, for example by manual entry in a computer or in the form of another type of manual provision. Providing may be performed actively, so that the item to be provided is actively supplied to the method, or, alternatively, also passively, so that merely an availability is ensured, for example a retrievability of the data.

Furthermore, a “biological system” is, within the context of the present invention, understood as meaning a system which comprises one or more organisms. If a plurality of organisms are provided, then these may be arranged in particular spatially connected and include a common metabolism. The organisms may be of the same type or else different. Possible nonlimiting examples of biological systems which may be mentioned are mammals, especially preferably mammals which are capable of being kept under controlled conditions, such as, for example, dogs, cats, mice or rats, with rats being especially preferred. Suitable methods for keeping for example mammals under controlled conditions are from WO2007/014825. Others which may be mentioned by preference are cell cultures and plants, in particular plants capable of being grown under controlled conditions in a greenhouse, such as, for example, Arabidopsis thaliana or rice.

Within the context of the present invention, a “metabolite” is understood as meaning in general intermediates of a metabolic process, in particular of a biochemical metabolic process. “Metabolism” refers to all the metabolic pathways of the biological system. Metabolites in the context of the invention are small molecules (known as “small molecule compounds”), such as substrates for enzymes of metabolic pathways, intermediates of such pathways, or their end products. Metabolic pathways are well known in the prior art and may vary between different species. Preferred are metabolic pathways at least of the citric-acid cycle, the respiratory chain, photosynthesis, photorespiration, glycolysis, gluconeogenesis, the hexose monophosphate pathway, the oxidative pentose phosphate pathway, the synthesis and the β-oxidation of fatty acids, the urea cycle, the biosynthesis of amino acids, the biosynthesis of the nucleotides, nucleosides and nucleic acids (including tRNAs, microRNAs (miRNA) or mRNAs), protein degradation, nucleotide degradation, biosynthesis or degradation of lipids, polyketides (including the flavonoids and isoflavonoids), isoprenoids (including the terpenes, sterols, steroids, carotenoids or xanthophylls), of the carbohydrates, of the phenylpropanoids and their derivatives, of the alkaloids, of the benzenoids, of the indoles, of the indole-sulfur compounds, of the porphyrins, of the anthocyanins, of the hormones, of the vitamins, of the cofactors such as prosthetic groups or electron carriers, of the lignins, of the glucosinolates, of the purines or of the pyrimidines. Accordingly, metabolites preferably belong to the following groups or classes of molecules: alcohols, alkanes, alkenes, alkynes, aromatic substances, ketones, aldehydes, carboxylic acids, esters, amines, imines, amides, cyanides, amino acids, peptides, thiols, thiol esters, phosphate esters, sulfate esters, thioethers, sulfoxides, ethers or their derivatives, or combinations of these. Metabolites may be primary metabolites, that is to say those which are required for the normal (physiological) function of the organism or of the organs. However, metabolites also comprise secondary metabolites which have an essentially ecological function, i.e. metabolites which allow the organism to adapt itself to the environment. Besides these primary and secondary metabolites, however, metabolites also comprise other, in some cases artificial, molecules. These are derived from exogenous molecules, which are, for example, taken up as active substances and can then be modified further in the metabolism. Metabolites may furthermore be peptides, oligopeptides, polypeptides, oligonucleotides and polynucleotides such as RNA or DNA. Especially preferably, metabolites have a molecular weight of from 50 da (daltons) to 30 000 da, more preferably less than 30 000 da, less than 20 000 da, less than 15 000 da, less than 10 000 da, less than 8000 da, less than 7000 da, less than 6000 da, less than 5000 da, less than 4000 da, less than 3000 da, less than 2000 da, less than 1000 da, less than 500 da, less than 300 da, less than 200 da, less than 100 da. Preferably, a metabolite in the context of the invention will, however, have a molecular weight of from approximately 50 da to approximately 1500 da.

Within the context of the present invention, an “effect” may, in principle, be understood to mean any change, capable of being determined, of at least one state of the biological system. In particular, this state may be a biological and/or biochemical and/or chemical state of the biological system. For example, this effect may be manifested by a change of a metabolome of the biological system. An effect in the context of the present invention may preferably be a change in cell morphology, in the genome, in the metabolome (in other words, in the qualitative or quantitative state of the metabolites in an organism or a subgroup thereof), in the proteome (in other words, in the qualitative or quantitative state of the proteins in an organism or subgroup thereof), in the transcriptome (in other words, in the qualitative or quantitative state of the transcripts in an organism or subgroup thereof), in the organ function, in the cell, tissue or organ vitality (toxicity) and/or in the psychological or social condition. It is to be understood that different effects may occur together in the context of the invention. Thus, a person skilled in the art is familiar with the fact that changes in cell morphology, in the genome, metabolome, proteome and/or transcriptome can induce changes in organ function, or may even influence the psychological or social condition of an organism. As a rule, it is desirable to detect effects such as organ damage or else psychological damage of organisms at an early point in time. To this end, it is especially preferred for the preceding modification to provide an indicator. With the aid of the modifications of the metabolome, it is, therefore, possible to predict organ dysfunctions or other damage. Naturally, positive effects such as the healing of specific diseases, yield-increasing properties in the cultivation of useful plants, or ecological damage in micro ecosystems may likewise be predicted in advance. Toxicological, pharmacological or bioenvironmental risk stratification of different effectors allows better control of the beneficial use or dealings with these effectors and maximal avoidance of harmful use or dealings with them.

Within the scope of the present invention an “effector” is understood as meaning, in principle, any influence on the biological system that might potentially have at least one effect, which may, in principle, be of any type, on the biological system. This potential effect may, in particular, be an effect of the abovementioned type, in particular a biochemical and/or biological and/or chemical effect, which might, in particular, be manifested by a change in the metabolism. Examples of such influences are exposure of the biological system to one or more chemical substances and/or compounds such as, for example, medicaments and/or pesticides, and/or physical action on the biological system, for example exposure of the biological system to electromagnetic radiation and/or particle radiation. A different duration and/or intensity and/or dose of the effect on the biological system may also be visualized by suitable effectors within the scope of the present invention. For example, different durations and/or intensities and/or doses of one and the same influence on the biological system may be considered to be different effectors. If, for example, an effector includes an exposure of the biological system to at least one chemical substance and/or chemical compound and/or to at least one radiation, then for example different durations and/or different intensities and/or different doses of this exposure may be considered to be different effectors. In this context, the duration and/or dose and/or intensity may also be graded into two or more levels. For example, when exposing the biological system to at least one chemical substance and/or chemical compound and/or to at least one radiation, a low dose and a high dose to which the biological system is exposed, as desired, will be predetermined, with exposure to the low dose and exposure to the high dose being considered to be two different effectors.

An effector may be used individually or in cooperation with other effectors so that for example a group of effectors acts together. Preferred effectors within the scope of the invention are chemical substances, pharmaceutical active substances and potential pharmaceutical active substances (candidate active substances), pesticides (herbicides, insecticides or fungicides), growth promoters, for example fertilizers, radiation treatments, modifications of the genetic material, for example in the form of random or deliberately generated mutations in the genome of an organism or by integration of genetic material via recombinant methods, and/or changes in environmental conditions (temperature, radiation, nutrition, water balance; gas composition and pressure of the surrounding atmosphere and the like).

Within the scope of the present invention, a “biomarker” generally refers to a state of a metabolite or of a specific group of metabolites. This state may be dependent in particular on constraints and/or parameters, for example age of the biological system, time of recording of the state, in particular a period after exposing the biological system to at least one effector, and optionally further information on the biological system, for example a sex. Thus, for example, a specific level of a metabolite or a particular group of metabolites may be specified as a biomarker as a function of a sex of the biological system and/or a point in time. As an alternative or in addition, a biomarker may also describe a state change of a metabolite or a specific group of metabolites, for example again as a function of constraints and/or parameters, for example of the abovementioned type. A distinction must be made between the biomarker itself, as a variable quantity, and its numerical value, with the aid of which, for example, it is possible to determine whether a biomarker is significant or not. As explained in greater detail hereinbelow, this determination of whether a biomarker is significant or not may, for example, be carried out by comparing its numerical value with one or more significance thresholds. A biomarker may, in principle, be expressed in any unit, for example in absolute units or in relative units, for example as a change relative to a reference value, in particular a normal state and/or a state in which the biological system is not exposed to the effector and/or the group of effectors and/or any effector in the first place.

A “profile” of a specific effector or group of effectors, in some cases also referred to as metabolic profile, is understood as meaning, in the context of the present invention, the totality of biomarkers which are recorded or have been recorded or can be recorded during or after exposure of the biological system to the effector. It therefore takes the form of a total set of biomarkers which can also be recorded, or of a subset of this total set which is taken into account for a specific study. This totality is preferably recorded under controlled and standardized conditions during or after exposure of the biological system to the effector or the group of effectors. For example, this profile may be a metabolome, or subset of the metabolome, caused by exposing the biological system to the at least one effector, or may comprise a metabolome or subset of a metabolome. A profile of metabolites may preferably be determined by methods which allow both quantitative and qualitative determination of the metabolites in the organism. To this end, a sample from the organism, which sample comprises a representative extract of the metabolites, may be analyzed. Suitable sample materials include bodily fluids such as blood, serum, plasma, urine, saliva, fecal matter, tear fluid, secretions or liquor, or tissue samples obtained via biopsy. Naturally, samples may also be samples from a micro ecosystem or from cultured cells. Samples may also be pretreated, for example to obtain a subcellular fraction (nuclei, endoplasmic reticulum, photosystem, peroxisomes, Golgi apparatus and the like) as the actual sample. The metabolic profiles of such samples can be obtained preferably by mass spectrometry techniques, NMR or other of the methods mentioned hereinbelow. Mass spectrometry techniques may generally be understood as meaning analyses of samples using mass spectroscopes and/or mass spectrometers, in particular mass separation techniques in which the ions are analyzed by photosensitive detectors. Mass spectrometry techniques and mass spectroscopy techniques can be used equally in the context of the present invention.

Before the actual qualitative and/or quantitative determination of the metabolites the latter may initially be separated further, which facilitates said determination, especially in the case of samples with a complex composition. To this end, it is possible to employ separation methods which are well known in the prior art. These are, preferably, chromatography-based techniques such as “liquid chromatography (LC)”, “high performance liquid chromatography (HPLC)”, gas chromatography (GC), thin-layer chromatography, size-exclusion chromatography or affinity chromatography. However, it is most preferred to employ LC and/or GC.

The actual qualitative and/or quantitative determination of the metabolites for a profile may then be carried out using suitable measurement or analytical methods. These preferably include: mass spectrometry such as GC-MS, LC-MS, “direct infusion” mass spectrometry, Fourier transformation ion cyclotrone resonance mass spectrometry (FT-ICR-MS), capillary electrophoresis mass spectrometry, (CE-MS), mass spectrometry coupled with “high-performance liquid chromatography”, quadrupole mass spectrometry, sequential mass spectrometries such as MS-MS or MS-MS-MS, “inductively coupled plasma” mass spectrometry (ICP-MS), pyrolysis mass spectrometry (Py-MS), ion mobility mass spectrometry or “time of flight” mass spectrometry (TOF). It is especially preferable to use LC-MS and/or GC-MS. These methods are described in Nissen, Journal of Chromatography A, 703, 1995: 37-57, U.S. Pat. No. 4,540,884 oder U.S. Pat. No. 5,397,894. The disclosure of these documents is herewith incorporated in its entirety. Alternatives to mass spectrometry which may be employed are: “nuclear magnetic resonance” (NMR), “magnetic resonance imaging” (MRI), Fourier transformation infrared analyses (FT-IR), ultraviolet (UV) spectroscopy, refraction indices (RI), fluorescence determinations, radiochemical determinations, electrochemical determinations, “light scattering” (LS), dispersive Raman spectroscopy or flame-ionization detectors (FID).

The methods mentioned hereinabove are particularly suitable for determining the states of a multiplicity of metabolites in samples and therefore for recording the values of the characteristics required for compiling the profile. The methods preferably provide a value for an identity parameter and one or more values for one or more parameters induced by the physical, chemical or biological properties of the measured metabolites. The biomarker profile can therefore include not only values which allow the chemical nature of the metabolites to be determined, but also a value capable of reflecting quantitative changes in the metabolites, in other words the amount measured in a particular sample. The methods mentioned hereinabove are also suitable for high-throughput analyses, so that different samples can be measured in an automated manner at short time intervals, and it is possible to compile a multiplicity of profiles, capable of being compared with each other, within a short time.

A “pattern” of a particular effector or group of effectors within the scope of the present invention is intended to mean a set of biomarkers which exhibit a significant change when the biological system is exposed to a particular effector or a particular group of effectors. For example, the biomarkers may be specified in the profile itself, or their values in absolute values and/or in relative values and/or in changes, for example rates of changes or changes in comparison with at least one normal value. The change may also be viewed in absolute values and/or in relative units, for example in comparison with at least one reference value and/or a normal state, in particular a state in which there is not, or has not been, any exposure to the effector and/or group of effectors and/or any effector.

What must be regarded as significant in this context depends on the individual case and can be preselected for example by a user and/or an evaluation device, and/or adjusted manually. In this context, for example, it is possible to pre-define one or more threshold values, also referred to hereinbelow as significance thresholds, for example one or more threshold values for one or more biomarkers and, in particular, for each biomarker or for each group of biomarkers a significance threshold, with the aid of which it is possible to decide whether a change is significant or not. These threshold values may also be variable in this context and, for example, adapted iteratively in order to adjust the sensitivity and/or selectivity.

Within the scope of the present invention, “selectivity” is generally understood as meaning the ability or property of systematically selecting specific elements from a total number of possible elements. The selectivity may therefore represent a measure of the narrowness of the selection. If, as is also possible within the scope of the present invention, a database is used, then the selectivity may be a measure of proportion of the selected elements in the total content of the data of the database, in particular for a database search by means of an index. Thus, for example, the selectivity may specify the number of biomarkers which are selected from the total number of biomarkers with the aid of the changes and assigned to the pattern. A high selectivity, for example owing to a high threshold value, generally leads to a lower number of biomarkers in the pattern, and a low selectivity, for example owing to a low threshold value, generally leads to a higher number of biomarkers in the pattern.

Within the scope of the present invention, “sensitivity” generally means the likelihood that an event which is genuinely positive will indeed be identified by a positive test result. For example, the sensitivity may represent a measure or a likelihood of whether a change of a particular biomarker can indeed be attributed to exposure to an effector or group of effectors, or whether the change is a random change, a measurement error or a noise or any other interfering influence. For example, the sensitivity may also describe a true-positive rate, a sensitivity or a hit ratio. The sensitivity may in particular be the proportion of events which are correctly identified as positive out of the total number of the events which are indeed positive, i.e. for example a proportion of the biomarkers with a change which has correctly been considered to be significant out of the total number of biomarkers which should exhibit a significant change due to exposure to the effector or group of effectors. A high sensitivity, for example owing to a low threshold value, generally leads to a high number of biomarkers in the pattern, while a low sensitivity, for example owing to a high threshold value, generally leads to a low number of biomarkers in the pattern.

The method according to the invention described hereinabove for establishing at least one pattern for at least one pre-defined effector having at least one determinable effect on a biological system permits the rapid convolution of extensive biological data. With the aid of the threshold values to be pre-defined, the most relevant biomarkers can be ascertained rapidly and reliably from a pre-defined profile. The method can also be carried out readily by computer implementation and may therefore be used in particular with the other method elements in high-throughput analysis. The patterns obtained by the method may be used in the applications discussed elsewhere in the description, and they allow a simplified and more efficient analysis of biological data sets.

In a preferred embodiment, the method according to the invention furthermore comprises the following steps:
d) providing a database in which profiles are stored for a multiplicity of further effectors;
e) establishing at least one further pattern of at least one further effector of the database.

In this manner, for example, an already existing database may be evaluated. By means of a multiplicity of measurements, for example, a database with profiles of different effectors can be collected. At least some of these effectors may, for example, be known effectors, in other words for example effectors whose effects on the biological system are known, for example their toxic effects. Within this database, an evaluation may be carried out by establishing profiles for one or more of the effectors.

In another preferred embodiment of the method according to the invention, it also comprises the following step:
f) the at least one further pattern established in method step e) is compared with the pattern established in method step c).

In this manner, for example, a comparison may be carried out for the pre-defined effector with the at least one further effector of the database, for example with at least one further effector which is already known. Thus, for example, a search may be carried out for similar effectors.

In a comparison of specific objects, various methods may generally be subsumable within the scope of the present invention. A comparison of two patterns may, for example, be carried out as to whether the patterns comprise the same biomarkers.

The result of this comparison may, for example, consist in a characteristic quantity which describes the degree of the match. This may be, for example, a percentage, for example 100 percent, if the first pattern consists of the same biomarkers as the second pattern. Correlation information or similar information may also be used in order to characterize the degree of the match.

Furthermore, as an alternative or in addition, it is also possible to compare the values of the patterns or at least to include the values in the comparison. Thus, it is possible to check not only whether the patterns comprise the same biomarkers, but also whether and optionally to what extent the values of these matching biomarkers coincide. Again, this can be done for example by using a correlation function or similar mathematical methods. Furthermore, it is also possible to simply pre-define one or more similarity thresholds so that for example a percentage deviation of the two values from each other which is above a pre-defined threshold is considered to be a non-match, and a percentage deviation of the values from each other which is below the threshold is considered to be a match. Other comparison methods may also be envisaged.

In another preferred embodiment of the method according to the invention, it also comprises the following steps:
g) checking whether the at least one further effector has at least one known effect;
h) comparing the at least one known effect with the previously determined determinable effect of the pre-defined effector.

This method variant thus relates to the actual comparison of the effects of the pre-defined effector, which must then also actually be determined or known in another way, with the known effect of the further effector.

For a comparison of the effects, in turn, it is possible to employ a variety of methods. Thus, for example, it is possible to categorize effects. In this way, for example, effects may readily be specified digitally, for example the effect is “hepatotoxic”. The effects may additionally be quantified further, for example in graded information such as “highly hepatotoxic”, “averagely hepatotoxic” or “weakly hepatotoxic”. Other quantifications may also be found. Thus, it is possible in turn to give a quantitative expression by quantifying the degree of the match instead of a simple digital expression “effect matches” or “effect does not match”. Again, this may be done, in turn, using known mathematical methods, for example by assigning numerical values to the graded information so that, for example, percentages or other quantitative information may in turn be used as an expression for the degree of the match.

If purely digital expressions of the type “effect matches” or “effect does not match” (for example “both effectors are hepatotoxic” or “one of the effectors is hepatotoxic, while the other one is not”) are given, then further evaluation is comparatively simple. If, however, intermediate values are allowed which categorize the degree of the match, then the operation may be carried out in turn with a threshold value method. Thus, for example, the degree of the match of the effects may be compared with one or more threshold values. If the degree of the match exceeds the threshold value, it can be assumed that the effects match, while a non-match may be assumed if the degree of the matches lies below the threshold value.

After this method has been carried out, there are several options. The starting point is found, as a rule, by the objectively determinable effects. If the effects match, while the patterns do not, then the pattern determination has not delivered the desired result and must optionally be improved. If, however, the effects match then the pattern comparison and the comparison of the effects deliver the same result, and the determination and comparison of the patterns therefore represent a successful way of comparing effects of different effectors or, for example, of predicting effects of unknown new effectors.

Accordingly, in another preferred embodiment of the method according to the invention, it also comprises the following step:
i) if an at least partial match of the patterns is found in method step f), carry out the following step:
i1) if no match is found in method step h): changing the significance threshold, in particular increasing the significance threshold, and repeating at least method steps b) and c).

This method variant represents an improvement in the pattern generation by correspondingly refining the algorithm. In other words, this method variant describes the case in which, although there is an at least partial match of the previously generated patterns (for example according to the description above a one hundred percent match, a match above a pre-defined threshold or a match by at least a pre-defined threshold), in fact no effect match or merely a minor effect match (for example below a pre-defined threshold) can be found for these effectors which, according to the ascertained patterns, should have an at least partial match of the effects (for example again by at least one pre-defined degree or by more than a pre-defined degree). In other words, this may comprise the case that, while the patterns match, the effects do not.

This is an indicator that the patterns have been selected incorrectly. For example, this may be attributable to biomarkers, whose values exhibit more of a random match, having been erroneously selected for the pattern even though these biomarkers do not represent suitable indicators for the suitable effect. This may for example be the case when the above-described threshold values in the pattern generation, in particular in method steps b) and c), have been selected unduly low for all the biomarkers, for a few biomarkers or for individual biomarkers. Correspondingly, according to the proposed method variant, a full or partial repetition of the pattern generation may be carried out. For example it is possible to automatically or manually increase all, a few or individual significance thresholds, so as to exclude from the patterns biomarkers which do not represent a suitable indicator for the effect.

In a preferred method variant, this can be carried out in particular in such a way that method steps i) and i1) are carried out repeatedly with a stepwise increase of the significance threshold.

Furthermore, the case may arise that no match of the patterns is found, even though a match of the effects can be found. This may mean in particular that biomarkers which would in fact have been suitable indicators of the effect have been excluded from the pattern generation by the threshold value method in method steps b) and c), for example because the threshold values were set too high.

In another preferred embodiment of the method according to the invention, it also comprises the following step:
j) if no match of the patterns is found in method step f), carry out the following step:
j1) if a match is found in method step h): changing the significance threshold, in particular reducing the significance threshold, and repeating at least method steps b) and c).

This in turn means that the pattern generation may be refined by adapting the threshold values. In this case, a method which is especially preferred is one in which method steps j) and j1) are carried out repeatedly with a stepwise reduction of the significance threshold.

The above-described method in one of the configurations described may be used in particular to group effectors according to their effect. In another aspect, therefore, the invention relates to a method of establishing a class of effectors for a pre-defined effect or group of effects. The method is based on the method presented above for establishing at least one pattern and comprises this method as a key component. The method comprises the following steps:
A) specifying at least one effector which is presumed to be assigned to the class of effectors, and assignation to the class of effectors;
B) establishing or updating at least one pattern of the at least one effector, in particular by using the method for establishing a pattern in one of the configurations described above;
C) providing a database in which profiles are stored for a multiplicity of further effectors;
D) searching for effectors with identical or similar profiles in the database;
E) assigning the effectors determined in step D) to the class of effectors.

In method step B), it is preferred to use a method of establishing a pattern in one of the configurations described above. In principle, however, other methods of establishing patterns may also be used, or already known patterns may be employed. For example, specific patterns of effectors of a particular effect are by now known from the literature in some cases, since, for example, it is known that specific effectors have an effect on specific metabolites.

A “class of effectors” within the scope of the present invention is understood as meaning a set of effectors which have the same known effect on the biological system or at least a similar effect on the biological system. The starting point for establishing a class of effectors is therefore a particular effect on the biological system, or a combined group of effects. The class of effectors may be a set of effectors which have at least one specific effect on the growth and/or functionality of the biological system, for example a specific toxic effect and/or a specific curative effect. A class of effectors may, in principle, first be configured as an empty set and then for example be added to later so that it preferably comprises at least one effector, in particular a plurality of effectors. As will be explained in greater detail below, a class of effectors may optionally also be established beforehand, for example firstly by at least one effector suspected of having the specific effect or the group of effects being assigned to the class of effectors. Thereafter, it is possible to supplement the class of effectors with one or more further effectors, as explained in greater detail hereinbelow, for example iteratively.

According to the possible effects, the class of effectors may comprise chemical compounds which mediate specific effects, for example organ toxicity, tissue toxicity or cell toxicity, optionally according to a specific molecular mode of action. For a toxicological risk stratification, it is helpful to know the precise mode of action for compounds. The effect mediated by a class of effectors may also be a pharmacological effect. Again, early categorization of an active substance is helpful for further pharmacological classification and allows early risk stratification so that unsuitable candidate active substances can promptly be eliminated before the start of clinical studies. Likewise, the effect mediated by a class of effectors may be, or comprise, a herbicidal, fungicidal or insecticidal effect or any combination of these effects. Again, early categorization of an active substance is helpful in the further classification and makes possible early risk stratification so that unsuitable candidate active substances can promptly be eliminated before the start of further studies. Genetic modifications as effectors may likewise form classes of effectors. Thus, for example, yield-increasing genetic modifications, or genetic modifications which increase pest resistance, may be combined in in each case one class of effectors. The method according to the invention preferably makes it possible to compile and collate effectors to form a class of effectors on the basis of the individual patterns of the individual effectors. The effectors of a class of effectors here preferably have essentially identical patterns. On the basis of these considerations, the method according to the invention for establishing a class of effectors makes possible said establishing of the class of effectors.

A method in which all or at least one of steps B) to E) is/are carried out repeatedly is preferred.

In a preferred embodiment of the method according to the invention, expert knowledge is employed in step A). For example, it is possible to employ the knowledge of an expert, for example a toxicologist, to pre-define at least one effector which is known to have a pre-defined effect, for example a pre-defined toxic effect.

The possibility of collating classes of effectors may furthermore be used to make predictions about at least one effect of at least one new, at least as yet not fully known effector and/or in order to determine at least one effect of an effector. In this context, it is possible in particular to use one or more classes of effectors which may have been established by the method of establishing a class of effectors for a pre-defined effect or group of effects according to one or more of the configurations described hereinabove. In principle it is also possible, as an alternative or in addition, however, to use classes of effectors obtained in other ways. Thus, particular classes of effectors are in turn known from the literature since, for example, the effects of many effectors are catalogued so that effectors with the same effect can be grouped.

Accordingly, in another aspect, the invention also relates to a method for identifying at least one effect of a pre-defined effector, comprising the following steps:
i) establishing at least one class of effectors for at least one known effect, in particular by a method according to the invention of establishing a class of effectors as described hereinabove;
ii) establishing at least one pattern of the pre-defined effector, in particular by one of the methods according to the invention for establishing a pattern as described hereinabove;
iii) comparing the pattern established in step ii) with the pattern of the class of effectors established in step i).

Identification of at least one effect may, in this context, generally be understood as ascertaining a result that the pre-defined effector has at least one particular, specifically indicated effect. As an alternative or in addition, the at least one effect may also be identified, which is likewise to be understood by identifying at least one effect, by carrying out a comparison with at least one other effector and, accordingly,
equating the effect of the pre-defined effector with at least one effect of the further effector,
identifying the effect of the pre-defined effector as being similar to the at least one effect of the further effector, or
identifying the effect of the pre-defined effector as being different from the at least one effect of the further effector.

Thus, for example, it may be ascertained that the pre-defined effector has at least one equal, similar or dissimilar effect to the at least one further effector with which the comparison is carried out.

In a preferred embodiment of the above method according to the invention, if a match or a similarity is found in step iii), the known effect of the class of effectors is equated with the effect to be ascertained of the pre-defined effector. This means that the effector in question, whose effect is to be ascertained, may in particular have the same effect as the class of effectors employed for the comparison, whose effect is in fact known. In this way, it is efficiently possible to quickly obtain at least one provisional estimate of the effect of this effector while reducing laboratory experiments to one unknown effector. This allows considerable research costs savings and it also makes it possible to reduce for example animal experiments to a minimum.

The method described hereinabove may, in principle, also be carried out without using a class of effectors, and methods using a class of effectors and methods without using a class of effectors may also be combined. If the route via at least one class of effectors is not selected, or at least not exclusively selected, it is possible also to resort directly to for example the ascertained patterns. Here, in particular, it is possible again to employ one or more patterns which have been obtained by means of the method of establishing at least one pattern according to one or more of the configurations mentioned hereinabove. Alternatively or as an addition, however, it is also possible in turn to employ one or more patterns which have been obtained in another way or which are known for example from the literature.

In a further aspect, therefore, the invention also relates to a method for identifying at least one effect of a pre-defined effector, comprising the following steps:
I) establishing at least one pattern of the pre-defined effector, in particular by one of the above-described methods according to the invention for establishing a pattern;
II) providing a database in which profiles are stored for a multiplicity of further effectors;
III) searching in the database for effectors with a similar or identical pattern to the pattern established in step I);
IV) checking whether the effectors ascertained in step III) have at least one known effect;
V) if a known effect is found in step IV), equating the effect of the pre-defined effector with the known effect.

As mentioned hereinabove, this method may in principle also be combined with the method in which the route via the at least one class of effectors is chosen. In both cases, effects of effectors can at least provisionally be predicted rapidly and reliably by comparison with known effectors, whether they now be grouped according to classes of effectors, or be individual.

The methods described hereinabove may be carried out fully or in part by means of a computer, or else they may be carried out at least in part using a computer. In particular, it is possible for one or more of the following method steps to be carried out by using a computer: a), b), c), d), e), f), g), h), i), i1), j), j1), A), B), C), D), E), i), ii), iii), I), II), Ill), IV), V), VI).

The invention therefore furthermore comprises a computer program having a program code for implementing the method according to any of the preceding method claims when the program is run in a computer. The computer program may be adapted to carry out, or at least assist, one or more or all of the method steps. In particular, all of method steps a) to c), all of method steps A) to E), all of method steps i) to iii) or all of method steps I) to VI) may be carried out by using at least one computer or computer network or using the computer program.

The computer program may in particular be configured as a saleable product. The computer program according to the invention is preferably stored on a machine-readable medium.

The invention furthermore comprises a computer, adapted to carry out a method according to any of the preceding method claims. The computer may generally comprise at least one dataprocessing device and/or one computer network.

Finally, the invention also relates to a data medium on which a data structure is stored, which carries out the method according to any of the preceding method claims, after loading in a working and/or main memory of a computer or computer network.

The proposed methods, the computer program, the computer and the data medium have many advantages over methods and devices known from the prior art, some of which have already been mentioned hereinabove. Thus, it is possible in particular to ascertain relationships and make predictions in very confusing experimental data sets. The data, for example raw data with measurement values for biomarkers of a multiplicity of different effectors, can be evaluated and categorized efficiently in this manner, and new types of presentation and/or representation may be found (for example in the form of patterns and/or classes of effectors), and/or data sets can be reduced considerably. Furthermore, owing to the possibility of predicting effects of previously unknown or only insufficiently known effectors, the experimental workload and the time for screening a multiplicity of new effectors can be reduced considerably.

### BRIEF DESCRIPTION OF THE FIGURES

Other possible details and features of the invention may be found in the following description of preferred exemplary embodiments. Some of the exemplary embodiments are represented schematically in the figures. Reference numbers which are the same in different figures refer to elements which are the same or functionally the same or correspond to one another in their function. The invention is not restricted to the exemplary embodiments.

In detail:

FIGS. 1A-1B

show an exemplary embodiment of a method according to the invention for determining a pattern of an effector;

FIGS. 2A-2D

show an exemplary embodiment of a method according to the invention of establishing a class of effectors;

FIGS. 3A-3B

show a first exemplary embodiment of a method for identifying at least one effect of a pre-defined effector;

FIGS. 4A-4B

show a second exemplary embodiment of a method for identifying an effect of a pre-defined effector; and

FIGS. 5A and 5B

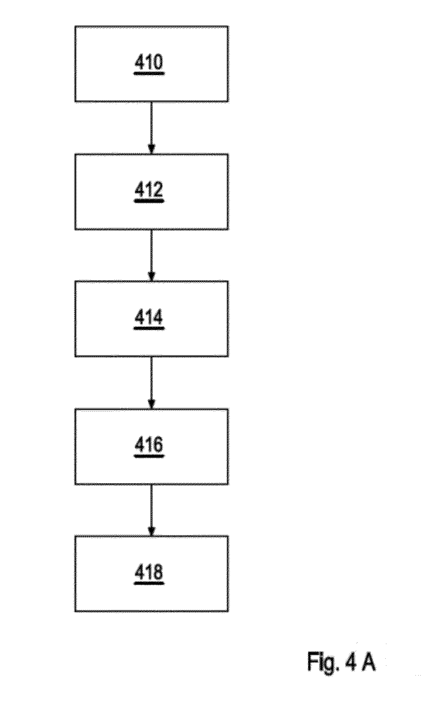

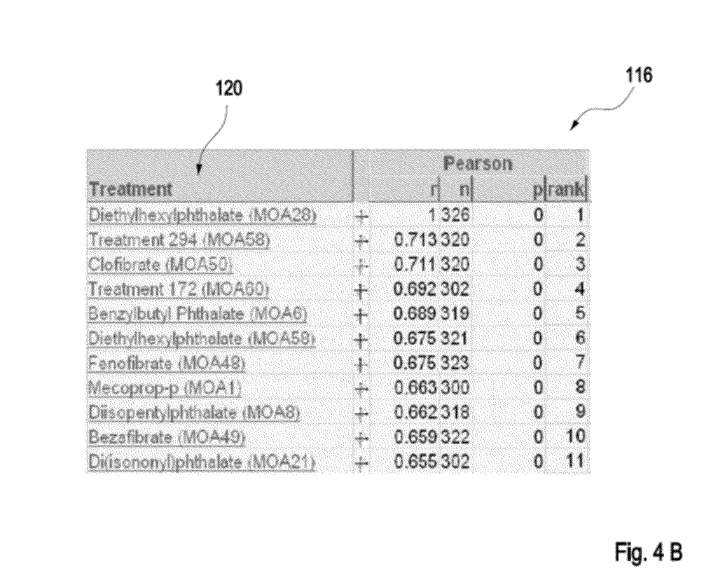

show a use example of the method according to FIGS. 4A and 4B for comparing effects of two chemically similar substances.

### EXEMPLARY EMBODIMENTS

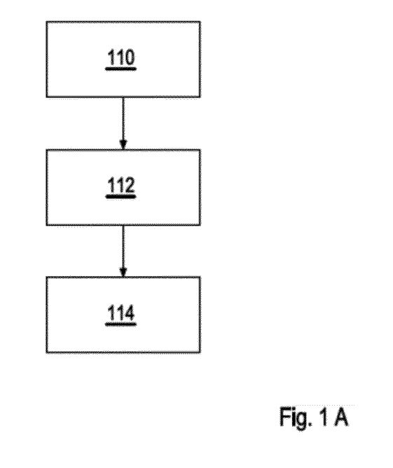

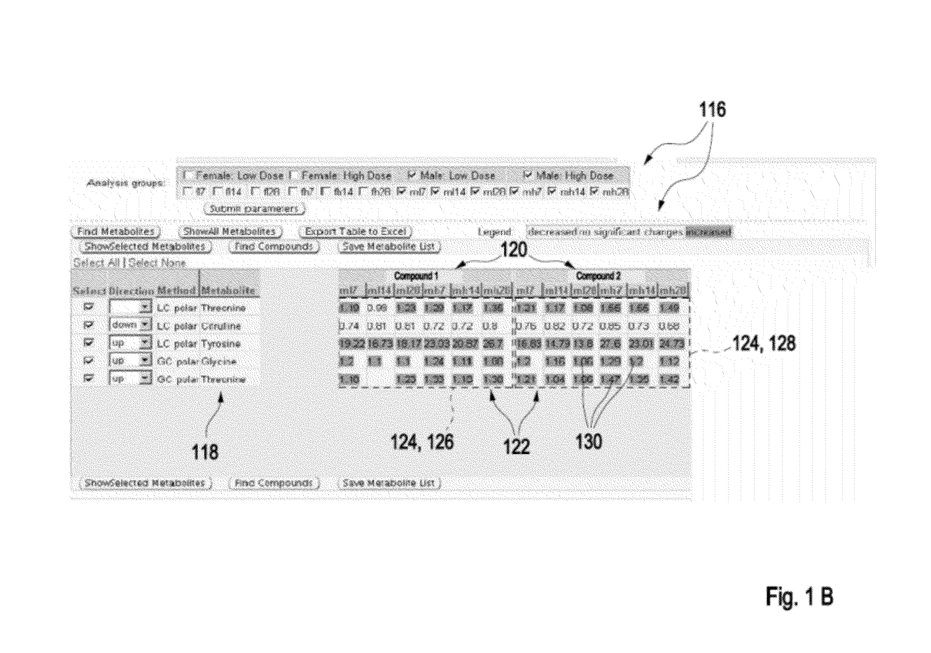

FIGS. 1A and 1B represent an exemplary embodiment of a method according to the invention for establishing at least one pattern for at least one pre-defined effector having at least one effect on a biological system, which effect is capable of being determined. In this context, FIG. 1 shows a schematic flow chart of this method, while FIG. 1B shows a screen capture of an exemplary screen representation. The two figures will be described together hereinbelow.

In FIG. 1A, reference number 110 denotes the provision of at least one profile of the pre-defined effector, reference 112 denotes the method step of comparing at least one value of at least one biomarker of the profile with at least one significance threshold in order to ascertain whether the biomarker is significant, and reference number 114 denotes the combining of significant biomarkers of the profile to form a pattern.

This method is represented by way of example in FIG. 1B. It shows a possible representation of a database 116 which is provided for the method according to the invention and from which an evaluation may be carried out by means of appropriate software, which implements the proposed method.

FIG. 1B represents various metabolites 118 in the column of a table headed “Metabolites”, the values or changes of which being monitored while exposing the biological system, in this case a rat, to various effectors 120. The metabolites 118 may optionally be selected from a list of possible metabolites by means of appropriate markings (column “Select”).

Various biomarkers 122 are recorded for each metabolite 118 and are specified in the rows following the metabolites 118. For example, the absolute values or changes of a particular metabolite 118 may be recorded for male (m) and female (f) test subjects (for example rats). Furthermore, biomarkers 122 may be recorded for exposure of the test subjects to a low dose (l) and for exposure to a high dose (h). Furthermore, the absolute values or changes of the metabolites 118 may be recorded after a pre-defined duration, for example after a duration in days, for example after 7 days (7), after 14 days (14) or after 28 days (28). Thus, for example, the biomarker 122 in the row allocated to the metabolite threonine in column ml7 denotes the absolute value or the change of the metabolite threonine when a male test subject (m) is exposed to a low dose (l) for measurement 7 days after exposure of the test subject to the effector 120, for example a substance with the designation “compound 1” or a substance with the designation “compound 2”. Each metabolite 118, therefore, has assigned to it a multiplicity of biomarkers 122. The total number of biomarkers 122 of a particular effector 120 is also referred to as profile 124. FIG. 1B represents profiles 124 or parts of these profiles 124 for the two effectors 120 compound 1 and compound 2, the profile for compound 1 being denoted by the reference number 126 and the profile for compound 2 being denoted by the reference number 128, by way of example.

Thus, FIG. 1B firstly shows the method step 110 of FIG. 1A of providing profiles 124, in this case optionally for a plurality of effectors 120, in this case by means of a database 116 and a corresponding option for representing, grouping and/or evaluating the biomarkers 122 comprised in this database 116, using a computer program.

Furthermore, on the other hand, FIG. 1B also shows indicatively the method step 112 mentioned in FIG. 1A of comparing the values of the biomarkers 122 with corresponding significance thresholds. For each biomarker 122 and/or for each metabolite 122, for example, one or more significance thresholds may be specified, which may also be capable of being influenced by a user. Thus, by way of example, in the table in which the profiles 124 are reproduced, biomarkers 122 which have a significantly increased value, that is for example an increase in the value of these biomarkers 122 above a significance threshold, are marked. Furthermore, although this cannot be seen from FIG. 1B, significantly reduced biomarkers 122 may be highlighted as an alternative or in addition, for example by means of a different color. For example, the column which is headed “Direction” may specify the principal direction of the change of the biomarkers 122 for each of the metabolites 118.

By means of this evaluation, the method step denoted hereinabove by the reference number 114 of the method according to FIG. 1A may be implemented. For example, all the biomarkers 122 of a profile 124, which exhibit a significant increase and/or a significant reduction, may be combined to form a pattern. All the biomarkers 122 with a gray background of the profile 128 for compound 2, which exhibit a significant increase, and/or all the biomarkers 122 not marked in FIG. 1B for compound 2, which exhibit a significant reduction, may be combined for example to form a pattern for compound 2. It should be pointed out that this pattern then comprises the biomarkers 122 for this effector 120, but preferably not the values of these biomarkers 122. Thus, the pattern for compound 2 in the exemplary embodiment shown in FIG. 1B comprises for example the biomarkers threonine ml7, threonine m114, threonine m128, threonine mh7, threonine mh14, threonine mh28, glycine m17, glycine m114 and the like, in other words the values shown with gray backgrounds in FIG. 1B of the table part to be allocated to the pattern 128, but not the numerical values entered in the fields of this part of the table.

In this manner, it is thus possible for example to establish a pattern for a pre-defined effector 120. This establishing may optionally also be carried out iteratively as described above, for example by interactive adaptation of threshold values. The pattern is symbolically denoted in FIG. 1B by the reference number 130. This symbolic reference number 130 will no longer be shown in the subsequent figures, so that in respect of this reference number reference may be made for example to FIG. 1B.

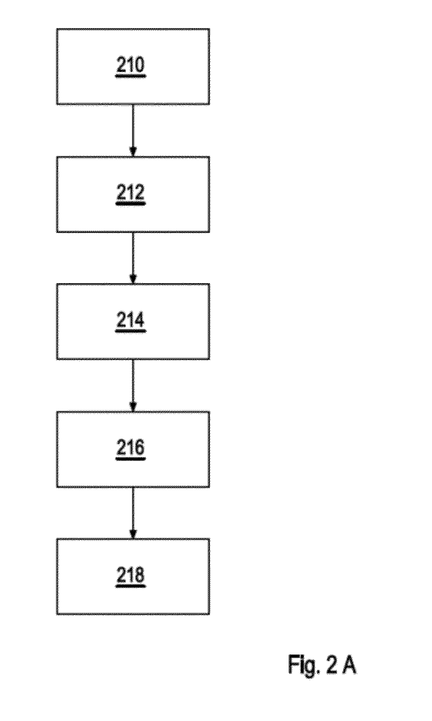

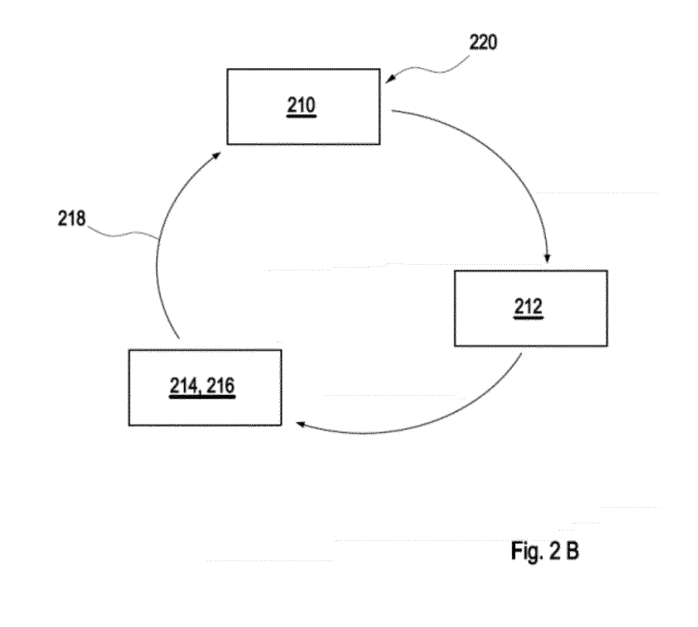

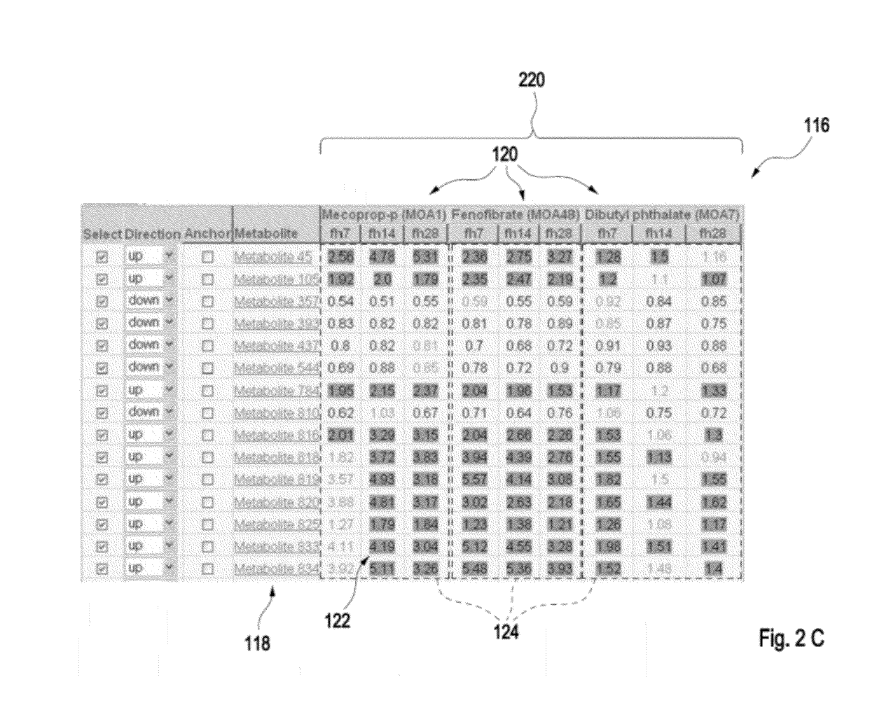

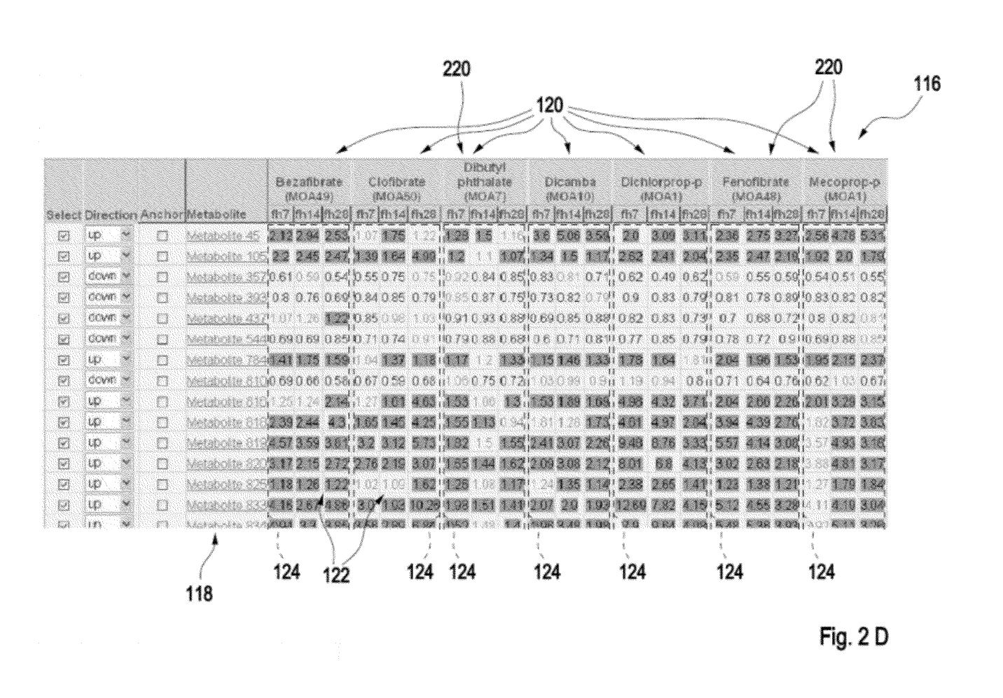

FIGS. 2A-2D show an exemplary embodiment of a method according to the invention of establishing a class of effectors for a pre-defined effect or group of effects by way of example. Here, FIG. 2A shows a schematic flow chart of an exemplary embodiment of the method according to the invention, FIG. 2B shows an iterative method variant, and FIGS. 2C and 2D show, in turn, screen representations of an exemplary embodiment of the method in various stages, using a database 116. The figures will again be explained together hereinbelow.

In FIG. 2A, the reference number 210 denotes a method step in which at least one effector 120 is specified which is likely to be assigned to the class of effectors to be established. This effector 120 is assigned to the class of effectors to be established.

In FIG. 2A, method step 210 is followed by a method step 212, in which at least one pattern of the at least one effector of the class of effectors is established. In an iterative method, which is explained with the aid of FIG. 2B, establishing is understood as meaning not recreating, but updating, the at least one pattern.

In a further method step which is likewise represented in FIG. 2A and denoted by the reference number 214, a database 116 is provided, where a multiplicity of further profiles 124 of effectors 120 are stored in the database 116.

In a method step denoted by reference number 216 in FIG. 2A, a search is made in the database 116 for effectors 120 with the same or similar profiles to those profiles of the effectors 120 which have already been assigned to the class of effectors. This may be done either by a direct comparison of the profiles 124 or by using patterns. For example at least one profile may be established for each, several or at least one further effector 120 in the database 116, for example a profile with the same biomarkers 122 as comprised by the at least one pattern established and/or updated in method step 212 for the effectors of the class of effectors. With the aid of this pattern comparison it is possible to ascertain whether the at least one further effector has an identical or similar profile 124. If, in method step 216, such effectors 120 which have the same or similar profiles to the effectors 120, which are already assigned to the class of effectors are ascertained, then these effectors 120 can be assigned to the class of effectors in a method step 218.

The method described in FIG. 2A may be carried out in particular iteratively. This is shown in FIG. 2B. There, again, in method steps 210 and 212, one or more effectors 120 which are likely to be assigned to the class of effectors to be established are initially specified, for example starting with at least one effector 120. The class of effectors is denoted by the reference number 220 in FIG. 2B.

One or more patterns are then determined in method step 212 for this class of effectors 220, which can initially be considered to be a provisional class of effectors 220.

In method steps 214 and 216, a database 116 with further effectors 120 is, in turn, specified, and a search is made in this database 116 for effectors 120 with the same or similar profiles 124, for example with identical or similar patterns 130. If this search is successful, then this at least one further effector 120 that has possibly been ascertained in this manner is assigned to the class of effectors 220 in method step 218. The method may then, as indicated in FIG. 2B, be carried out again in order to ascertain further effectors 220 which are to be assigned to the class of effectors 220.

This method will be illustrated in greater detail by way of example with the aid of FIGS. 2C and 2D. Thus, for example, FIG. 2C again shows a screen representation which explains method steps 210 and 212. This representation is a mode of representing a part of a database 116.

In this example, it is desired to establish, by way of example, a class of effectors 220, which comprises effectors 120 which have an effect of the peroxisome proliferation type.

For this peroxisome proliferation effect, a provisional class of effectors 220 is initially formed which is based for example on expert knowledge and/or literature information. The expert knowledge consists for example in that the effectors 120 of the mecoprop-p, fenofibrate and dibutyl phthalate type have the abovementioned effect. These effectors 120 are therefore assigned to the provisional class of effectors 220, as shown in FIG. 2C. From the database 116 and/or in another way, profiles 124 are specified for these effectors. These profiles 124, which are represented in FIG. 2C by way of example and in some cases as excerpts, again comprise a multiplicity of biomarkers 122. For example, similarly as in the representation in FIG. 1B, these biomarkers 122 are biomarkers which are characterized by the sex of the test subject, the level of the dose and/or the time after exposure of the test subjects to the effector 120, in each case for different metabolites 118. It should be pointed out that the representation in FIG. 2C is to be taken merely by way of example and may, in turn, comprise for example an excerpt of examples. In contrast to the representation in FIG. 1B, the metabolites 118 are merely specified by numbers.

Furthermore, biomarkers 122 whose values exhibit a significant change, in turn, are shown against a gray background in FIG. 2C, in respect of which reference may be made for example to the description of FIG. 1B. From this comparison of the biomarkers 122 or their values with corresponding significance thresholds, a pattern can, in turn, be compiled. For example, this pattern may comprise biomarkers 122 which exhibit a significant change in the same direction in all three profiles 124 of the three effectors 120 of the provisional class of effectors 220. Since, for example, in the case of all effectors 120 for the metabolite of the “metabolite 45” type, the biomarker 122 with the designation fh7 and the biomarker with the designation fh14 exhibit a significant change, these biomarkers 122 should preferably be assigned to pattern 130. In this way, a pattern can be collated for the provisional class of effectors 220.

With this provisional class of effectors 220, a search can then be made in the database 116 for further effectors 120 which are likewise to be assigned to the class of effectors 220. This is represented by way of example in FIG. 2D, in a representation similar to FIG. 2C. Biomarkers 122 for a multiplicity of metabolites 118 are again entered in the rows of the tabular representation. These biomarkers are in turn assigned to effectors 120. Besides the effectors 120 of the type mecoprop-p, fenofibrate and dibutyl phthalate which have already been assigned to the class of effectors 220, the effectors bezafibrate, clofibrate, dicamba and dichlorprop-p and their associated profiles 124 are indicated as further effectors 120. With the aid of a comparison of the patterns 130, which are not explicitly identified in FIG. 2D likewise as in FIG. 2C, it is possible to ascertain further effectors 120 which have the same or similar profiles 124, and in particular which have the same or similar patterns 130. In this manner it is possible to determine, for example by groups or iteratively, further effectors 120 which are to be assigned to the class of effectors 220.

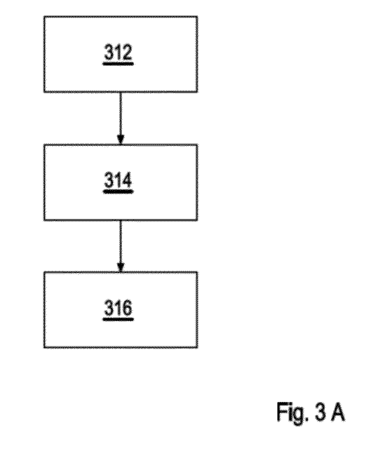

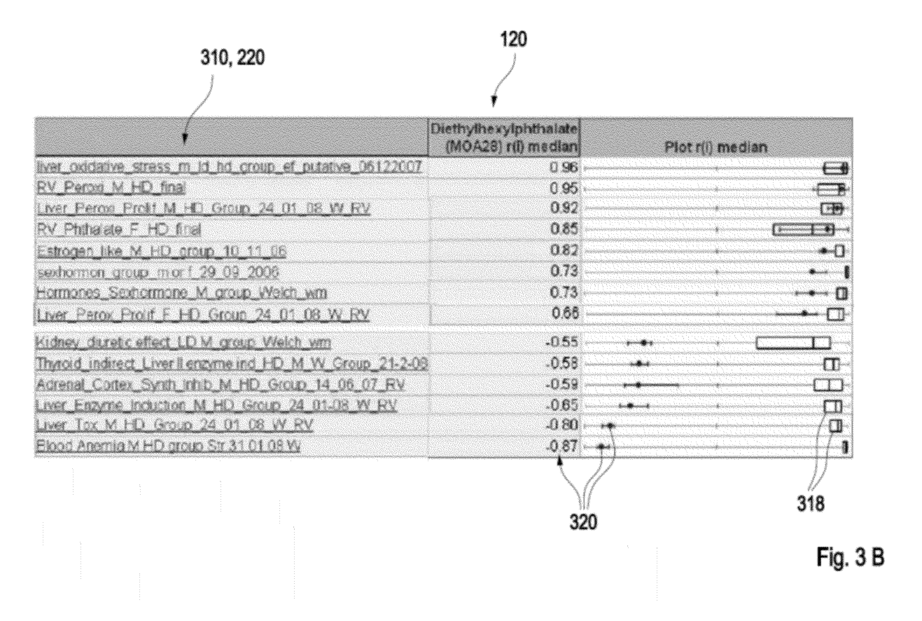

FIGS. 3A and 3B represent a first exemplary embodiment of a method according to the invention, by means of which at least one effect of a predetermined effector 120 can be ascertained. Possible effects are denoted in FIG. 3B by the reference number 310. FIG. 3A in turn shows a schematic flow chart of a basic form of the exemplary embodiment of the proposed method, while FIG. 3B shows an example in tabular form in which a search is made in a database for effects 310 for the effector 120 of the diethylhexyl phthalate type.

In the method represented in FIG. 3A, at least one class of effectors for at least one known effect 310 is initially established in method step 312. For example, an effect 310 may be specified for which a class of effectors is determined, for example by the method described with reference to FIGS. 2A-2D.

In method step 314, at least one pattern 130 is established for the pre-defined effector 120, whose effect 310 is to be ascertained.

In method step 316, finally, a comparison is made between the pattern 130 ascertained in method step 314 for the pre-defined effector 120, whose effect is to be ascertained, and the at least one pattern 130 of the effectors 120 combined in the at least one class of effectors 220.

With the aid of FIG. 3B, the method described in FIG. 3A in abstract terms will be presented with a specific exemplary embodiment. In the representation shown here, which, for example, again shows a screen representation of a computer-aided implementation of the method described in FIG. 3A, one or more effects of the effector 120 of the diethylhexyl phthalate type are to be determined.

To this end, a multiplicity of effects 310 are entered in the first column of the table shown in FIG. 3B. These effects 310 in the representation are provided by way of example with more or less characterizing designations. Thus, for example, the designation “liver_oxidative_stress_m_ld_hd_group_ef_{—putative}_{—}06122007” may specify a particular type of oxidative stress on the liver. The other designations in the first column of the table in FIG. 3B show other types of effects 310, which will not be dealt with in detail here.

Preferably, a class of effectors or optionally a plurality of classes of effectors have beforehand been determined for each of these effects 310, for example with the aid of the method described in FIGS. 2A to 2D. For example, an class of effectors 220 may be stored for each effect 310 with an associated pattern 130 of this class of effectors 220.

Furthermore, the second and third columns of the table according to FIG. 3B represent in a highly simplified way how a pattern 130 of the effector 120, whose effect is to be ascertained (in this case by way of example diethylhexyl phthalate), is compared with the patterns of the classes of effectors 220. In the exemplary embodiment represented or else in other exemplary embodiments of the present invention, this is done by means of, for example, what is known as a Pearson correlation. The latter is a dimensionless measure of the degree of a linear relationship between interval-scaled features. The value shown here is the Pearson correlation coefficient r. In the third column, for each effect 310 or each class of effectors 220, Pearson correlation coefficients 318 are entered in box form, including their confidence intervals. These Pearson correlation coefficients 318 basically indicate the reliability of the patterns of the classes of effectors 220 which have been determined for example by means of the iterative method described in FIG. 2B. For a fully reliable pattern 130, the Pearson correlation coefficient 318 would lie precisely at +1, in other words in each case on the far right-hand end in the third column in FIG. 3B, and the uncertainty interval would equal 0. Alternatively or in addition to the Pearson correlation, or the Pearson correlation coefficient, other types of correlations or correlation coefficients may also be employed. For example, Spearman correlations or Spearman correlation coefficients may be employed as an alternative or in addition.

Furthermore, the correlation of the pattern determined in step 314 for the pre-defined effector 120 whose effect is to be determined is entered in FIG. 3B in the second column numerically and in the third column in the form of dots, respectively with an uncertainty interval for each effect 310 or class of effectors 220. What is shown here is in each case the Pearson correlation coefficient r in numerical form (in the second column) and as a plot on a scale from −1 (left-hand end) to +1 (right-hand end) in the third column. Thus, this Pearson correlation coefficient 320 indicates the degree of the match of the pattern 130 of the effector 120 whose effect is to be determined with the pattern 130 of the class of effectors 220 in each case. In an ideal case, in other words when the effector 120 in question has the same effect as the classes of effectors 220, this Pearson correlation coefficient 320 in the third column in FIG. 3B should lie at the right-hand end of the scale, in other words at +1.

In the specific embodiment in FIG. 3B, the latter is the case in particular for the first four classes of effectors 220. Accordingly, it can be stated with high likelihood that the effector in question, diethylhexyl phthalate, has the same effect as these first four classes of effectors. A relatively high degree of match can also still be found in respect of the fifth to eighth classes of effectors 220 in the table in FIG. 3B.

On the other hand, there is a comparatively low match for the other classes of effectors 220. Accordingly, it can be ruled out with a high likelihood that the effector diethylhexyl phthalate has the same effect as these classes of effectors 220.

As a result of the method according to FIGS. 3A and 3B, the effects of the first four classes of effectors 220 in the table according to FIG. 3B can therefore be assigned with high likelihood to the effector diethylhexyl phthalate. In this way, a number of effects have here been ascertained for this effector 120 in the present exemplary embodiment.

FIGS. 4A and 4B represent an alternative method to FIGS. 3A and 3B for identifying at least one effect of a pre-defined effector. Again, FIG. 4A shows a schematic flow chart of this method.

Method step 410 in FIG. 4A represents a method step in which at least one pattern 130 of the pre-defined effector 120 whose effect is to be identified is established. Again, this may be done for example by means of the method described in FIGS. 1A and 1B.

Reference number 412 denotes a method step in which a database 116 is provided in which profiles 124 are stored for a multiplicity of further effectors 120. In respect of this, again, reference can be made to the exemplary embodiments above.

Reference number 414 denotes a method step in which a search is made in the database 116 for effectors 120 with patterns similar or identical to the pattern 130 established in step 410. This may for example again be done by means of a comparison using a correlation method. In this respect, reference may for example again be made to the description of FIG. 3B, and a similar correlation method may for example also be employed in method step 414 for comparing the patterns 130.

In method step 416 a check is carried out as to whether the effectors 120 ascertained in step 414 (assuming that at least one such effector 120 has been ascertained—which need not necessarily be the case) have at least one known effect. This may for example be done by the effectors 120 ascertained in step 414 already having been assigned to a class of effectors 220 and/or by again using expert knowledge about the effectors 120 which have been ascertained.

Method step 418 represents a conditional method step. Specifically, if a known effect has been found in method step 416, then the effect of the pre-defined effector is equated with the known effect (likewise, a plurality of known effects may be identified). At least one effect of the effector 120 in question is thereby identified. Otherwise, that is to say when no known effect is found in step 416, the method in FIG. 4 was without a result.

FIG. 4B illustrates this method by way of example with reference to the example of the effector diethylhexyl phthalate. A pattern 130 is established for this effector 120, and this pattern 130 is compared with known patterns 130 of a plurality of other effectors 120 in a database 116. FIG. 4B shows a pictorial representation of a result of this pattern comparison; since the effector in question, diethylhexyl phthalate, is also contained in the database 116, it is, in turn, also listed per se in the representation according to FIG. 4B.

Furthermore, comparison results of the pattern 130 of the pre-defined effector diethylhexyl phthalate with the respective pattern 130 of the respective effector 120 are represented in the third column of the table shown in FIG. 4B for each effector 120. Again, these comparisons are carried out by way of example by means of a Pearson correlation. Again, what is shown in each case here is the Pearson correlation coefficient r. Matches can be found with the aid of these correlation results, and a ranking may be carried out as a prioritization according to the degree of the match. The greatest degree of match (rank 1), with a Pearson correlation coefficient r equal to 1, is, of course, represented by diethylhexyl phthalate itself since the pattern 130 of this effector 120 naturally gives a perfect match with its own pattern 130.

As the next-closest pattern, with a Pearson correlation coefficient r=0.713, an effector 120 denoted here as “treatment 294” was ascertained in the table according to FIG. 4B. It is therefore to be expected that the effector in question, diethylhexyl phthalate, has the same or at least a similar effect to the effector “treatment 294”.

Method steps 416 and 418 are not represented in FIG. 4B. If it is found for example that the effector “treatment 294” has a known effect 310, for example on the basis of expert knowledge or on the basis of a known assignment of this effector to a class of effectors 220 with at least one known effect 310, then, based on the high Pearson correlation coefficient r equal 0.713, which may for example lie above a pre-defined match threshold, it can be ascertained that the effector in question, diethylhexyl phthalate, too, has this effect. At least one effect of this effector diethylhexyl phthalate has thus been identified.

In general, for example in the method in FIGS. 4A and 4B, one or more match thresholds may be pre-defined. These match thresholds may for example be selected more or less arbitrarily, and may for example be set above r equals 0.5, preferably r>0.6 and especially preferably r>0.7. Iterative adaptation of this match threshold is also possible, for example when additional tests have ascertained that this threshold has been selected too low, that is to say that the effector 120 in question has incorrectly been assigned an effect 310 which, in fact, it does not have.

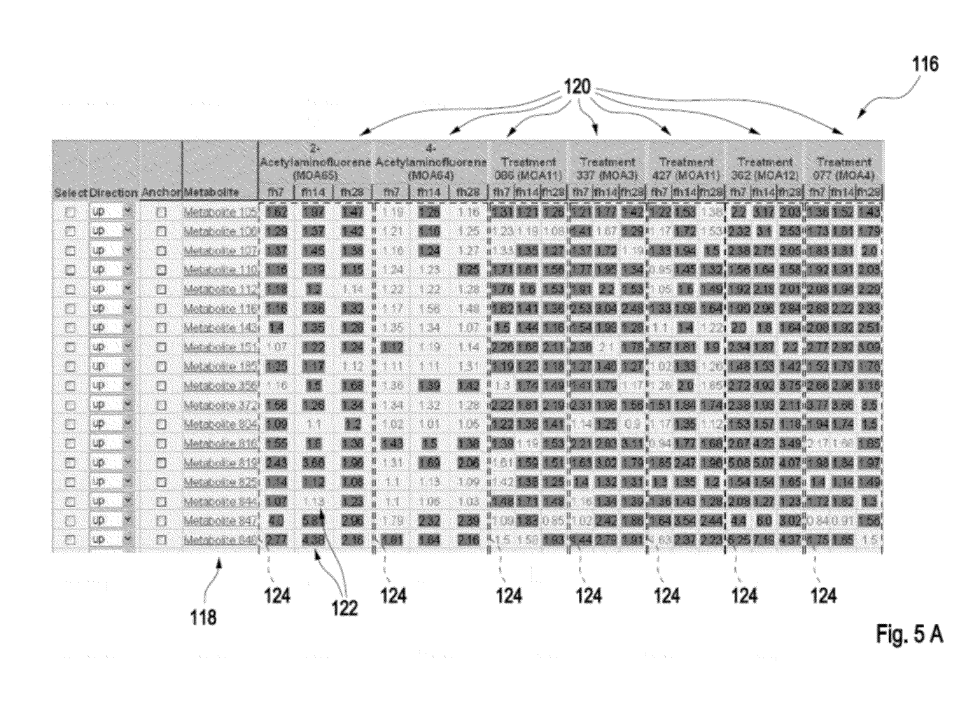

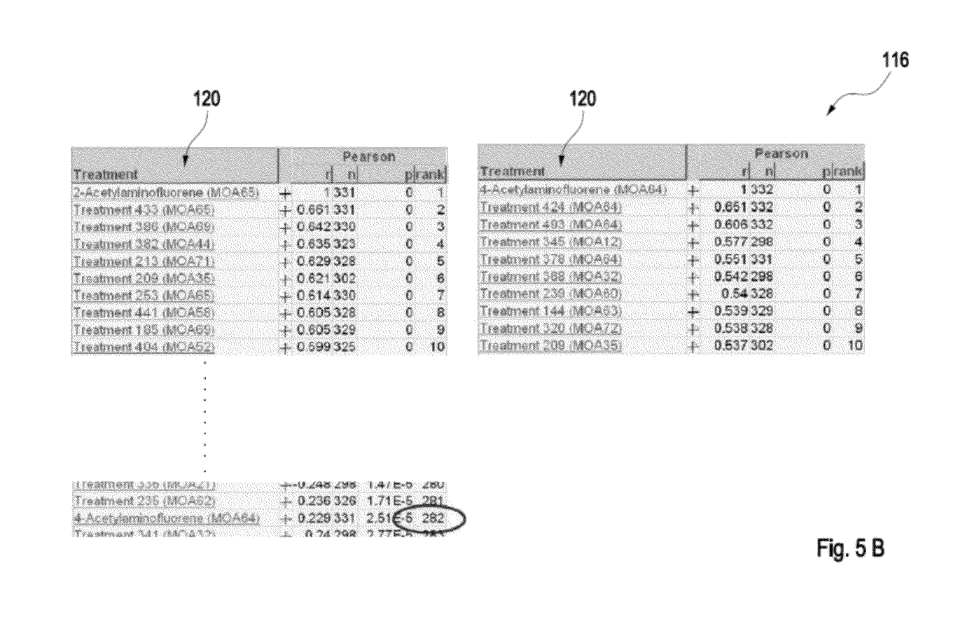

The efficacy of the method described in FIGS. 4A and 4B will be illustrated in greater detail with the aid of FIGS. 5A and 5B. Two chemically similar substances are studied in this exemplary embodiment, which are:

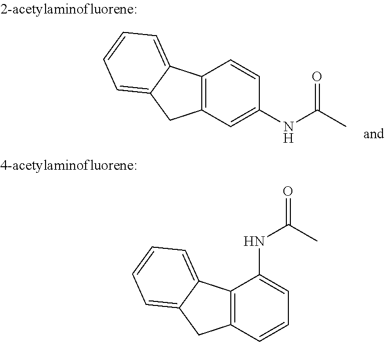

2-Acetylaminofluorene is known to be an effector 120 which has the following effects 310:
potent liver enzyme inducer,
liver carcinogen,
immunosuppressant,
bladder carcinogen.

For the chemically similar substance 4-acetylaminofluorene, on the other hand, it is known that this effector 120 has the following effects 310:
weak liver enzyme inducer,
no liver carcinogen,
lipid accumulation in the liver,
immunosuppressant.

Despite the chemical similarity, very different effects 310 of these effectors 120 can therefore be observed in practice. The question is whether these different effects can be identified by means of a method according to the present invention.

Accordingly, in a representation similar to FIG. 2C, FIG. 5A represents a comparison of the metabolic profiles 124 of these effectors 2-acetylaminofluorene and 4-acetylaminofluorene with various other effectors 120. By means of the method described hereinabove, for example similarly as in FIG. 2C, it is possible in this manner to ascertain patterns 130 for each of these effectors 120. In a similar representation to FIG. 4B, on the other hand, FIG. 5B shows a pattern comparison of the patterns 130 ascertained with the aid of FIG. 5A. A ranking with the aid of the Pearson correlation coefficients is again represented here, in a similar representation to FIG. 4B. The left-hand table in FIG. 5B shows a comparison of the pattern 130 for the effector 2-acetylaminofluorene with the other effectors 120 in FIG. 5A, and the right-hand table shows a comparison of the pattern 130 of the effector 4-acetylaminofluorene with the patterns of the remaining effectors 120 in FIG. 5A.

Correspondingly, the effector 2-acetylaminofluorene itself in turn naturally occupies the first position of the ranking in the left-hand table in FIG. 5B, with a Pearson correlation coefficient r=1. In the right-hand table, the effector 4-acetylaminofluorene correspondingly occupies the first position, likewise with a Pearson correlation coefficient r=1. These effectors in question, 2-acetylaminofluorene and 4-acetylaminofluorene, are, respectively, followed by similar effectors in order of their similarity.

In the table excerpt in FIG. 5B at the bottom it can be seen that the chemically similar effector 4-acetylaminofluorene does not occur in the left-hand table, in which 2-acetylaminofluorene is compared with the other effectors 120 in FIG. 5A, until the 282^{nd} position, with a very low Pearson correlation coefficient of r=0.229.

These results impressively show that the method described with the aid of FIGS. 4A and 4B for comparing effects of different effectors 120 reflects the actual situation very well. Furthermore, this exemplary embodiment shows that even chemically similar effectors 120 may have very different effects 310.

### LIST OF REFERENCE SYMBOLS

110 Provision of at least one profile of the pre-defined effector

112 Comparison of at least one value of at least one biomarker of the profile with at least one significance threshold

114 Combination of significant biomarkers of the profile to form a pattern

116 Database

118 Metabolites

120 Effectors

122 Biomarkers

124 Profile

126 Profile for compound 1

128 Profile for compound 2

130 Pattern

210 Specification of at least one effector

212 Establishing or updating of at least one pattern of the at least one effector

214 Provision of a database with profiles for further effectors

216 Search for effectors with the same similar profiles

218 Assignment of the ascertained effectors to the class of effectors

220 Class of effectors

310 Effect

312 Establishing at least one class of effectors for at least one known effect

314 Establishing at least one pattern of the pre-defined effector

316 Comparison of the pattern from step 314 with pattern from step 312

318 Pearson correlation coefficient for patterns of the classes of effectors

320 Pearson correlation coefficient for pattern of the effector

410 Establishing at least one pattern of the pre-defined effector

412 Provision of a database in which profiles are stored for a multiplicity of further effectors

414 Searching in the database for effectors with a pattern similar or identical to the pattern established in step 410

416 Checking whether the effectors ascertained in step 414 have at least one known effect

418 If a known effect is found in step 416, equating the effect of the pre-defined effector with the known effect

1.-18. (canceled)

19. A method for establishing at least one pattern for at least one pre-defined effector having at least one determinable effect on a biological system, comprising the following steps:
a) providing at least one profile of the at least one pre-defined effector;
b) comparing at least one value of at least one biomarker of the at least one profile, with at least one significance threshold in order to ascertain whether the at least one biomarker is significant;
c) combining significant biomarkers of the at least one profile to give a pattern.

20. The method according to claim 19, further comprising:
d) providing a database in which profiles are stored for a multiplicity of further effectors;
e) establishing at least one further pattern of at least one further effector of the database.

21. The method according to claim 20, further comprising:
f) comparing the at least one further pattern established in method step e) with the pattern established in method step c).

22. The method according to claim 21, further comprising:
g) checking whether the at least one further effector has at least one known effect;
h) comparing the at least one known effect with the previously determined determinable effect of the pre-defined effector.

23. The method according to claim 22, further comprising:
i) if at least partial match of the patterns is found in method step f), carrying out the following step:
i1) if no match is found in method step h): changing the significance threshold, in particular increasing the significance threshold, and repeating at least method steps b) and c).

24. The method according to claim 23, wherein method steps i) and i1) are carried out repeatedly with a stepwise increase of the significance threshold.

25. The method according to claim 19, further comprising:
j) if no match of the patterns is found in method step f), carry out the following step:
j1) if a match is found in method step h): changing the significance threshold, in particular reducing the significance threshold, and repeating at least method steps b) and c).

26. The method according to claim 25, wherein method steps j) and j1) are carried out repeatedly with stepwise reduction of the significance threshold.

27. A method of establishing a class of effectors for a pre-defined effect or group of effects, comprising the following steps:
A) specifying at least one effector which is presumed to be assigned to the class of effectors, and assignation to the class of effectors;
B) establishing or updating at least one pattern of the at least one effector, by the method according to claim 19;
C) providing a database in which profiles are stored for a multiplicity of further effectors;
D) searching for effectors with identical or similar profiles in the database;
E) assigning the effectors determined in step D) to the class of effectors.

28. The method according to claim 27, wherein all or at least one of steps B) to E) are carried out repeatedly.

29. The method according to claim 19, wherein expert knowledge is employed in step A).

30. A method for identifying at least one effect of a pre-defined effector, comprising the following steps:
i) establishing at least one class of effectors for at least one known effect, by the method according to claim 27;
ii) establishing at least one pattern of the pre-defined effector by:
a) providing at least one profile of the at least one pre-defined effector;
b) comparing at least one value of at least one biomarker of the at least one profile, with at least one significance threshold in order to ascertain whether the at least one biomarker is significant;
c) combining significant biomarkers of the at least one profile to give a pattern;
iii) comparing the pattern established in step ii) with the pattern of the class of effectors established in step i).

31. The method according to claim 30, wherein, if a match or a similarity is found in step iii), the known effect of the class of effectors is equated with the effect to be ascertained of the pre-defined effector.

32. A method for identifying at least one effect of a pre-defined effector, comprising the following steps:
I) establishing at least one pattern of the pre-defined effector, by a method according to claim 19;
II) providing a database in which profiles are stored for a multiplicity of further effectors;
III) searching in the database for effectors with a similar or identical pattern to the pattern established in step I);
IV) checking whether the effectors ascertained in step III) have at least one known effect;
V) if a known effect is found in step IV), equating the effect of the pre-defined effector with the known effect.

33. A computer program having a program code for implementing the method according to claim 19 when the program is run in a computer.

34. The computer program according to claim 33, stored on a machine-readable medium.

35. A computer, adapted to carry out a method according to claim 19.

36. A data medium on which a data structure is stored, which carries out the method according to claim 19, after loading in a working and/or main memory of a computer or computer network.
